(19) United States
(12) Patent Application Publication
(10) Pub. No.: US 2008/0076020 A1
(43) Pub. Date: Mar. 27, 2008

(54) Electrical Connection Structure for a Core Assembly of a Secondary Lithium Battery

(76) Inventor: Donald P. H. WU, Hsin-Feng Hsiang (TW)

Correspondence Address: Dr. BANGER SHIA, 102 Lindencrest Ct., Sugar Land, TX, 77479-5201, US

(21) Appl. No.: 11/534,302

(22) Filed: Sep. 22, 2006

(51) Int. Cl. H01M 2/26

(52) U.S. Cl. 429/161; 429/211; 429/94

(57) ABSTRACT

An electrical connection structure for a core assembly of a secondary lithium battery employs a conductive connecting assembly as an electrical conductive connection to connect the core assembly to the positive or negative lead terminal. The conductive pressing piece is a flexible structure. By such arrangements, even if there is a dimension error in the core or the case, which can be overcome by the deformation of the conductive fixing assemblies, and thus the battery can be assembled successfully. The bolt enables the conductive pressing piece to be maintained in a close electrical contact with the positive or negative lead area, and the connecting portion is electrically connected to the positive lead terminal or the negative lead terminal of the case.

### BACKGROUND OF THE INVENTION

1. Field of the Invention

The present invention relates to an electrical connection structure for a core assembly of a secondary lithium battery, and more particularly to a design of the connection between the core assembly inside the battery and the positive or negative lead terminal on the case of the battery.

2. Description of the Prior Art

FIG. 1 shows “an electrode assembly for a lithium secondary battery” disclosed in an earlier U.S. patent application Ser. No. 11/455119 of the inventor, and the earlier application mainly aims at the solution to the problem of the conventional electrode assembly, including the time consuming welding process, the complicated components and the production process, since the electrode assembly must be formed or welded with a plurality of leads, and then the leads are welded or connected to the battery terminal.

The positive and negative layers of the electrode assembly 10 are formed at a side thereof with a large negative lead area 111 and a large uncoated positive lead area 112. In addition, a large collecting area 121 is formed in the mid of the lead terminal 12 and is located correspondingly to the negative lead area 111 or the positive lead area 112. And then a pressing piece 131 the clasping assemblies 13 is fixed outside the positive lead area 111 or the negative lead area 112. In this way, the two conductive pressing pieces 131 are firmly pressed against the positive lead area 111 or the negative lead area 112. On the one hand, the respective layers of the positive lead area 111 or the negative lead area 112 are pressed closely against one another, and on the other hand, the positive lead area 111 or the negative lead area 112 is allowed to be maintained in a tight electrical contact with the collecting area 121 (as shown in FIG. 2).

It is to be noted that the size of the respective components of the abovementioned lithium secondary battery must be controlled precisely; otherwise, the electrode assembly cannot be fitted into the battery case, if the battery case, the core or the lead terminal has an error in dimension. For example, if the battery case is too short or the core is too high, the core cannot be sealed hermetically in the battery case, or, if the electrode assembly is too short, as a result, only one end of the electrode assembly can be fixed to the battery case, and the other end of the electrode assembly will be too short to reach the battery case, so it cannot be fixed.

It is learned from the abovementioned explanation that the earlier application simplifies the electrical connection process of the leads of the electrode assembly. However, the size of the components of the electrode assembly must be controlled precisely, otherwise the electrode assembly cannot be assembled.

The present invention has arisen to mitigate and/or obviate the afore-described disadvantages.

### SUMMARY OF THE INVENTION

The primary objective of the present invention is to provide an electrical connection structure for a core assembly of a secondary lithium battery, wherein the conductive connecting assembly is used as an electrical conductive connection for connecting the core assembly to the positive lead terminal or the negative lead terminal. The conductive connecting assembly includes at least one bolt and a conductive pressing piece, and the conductive pressing piece is a flexible structure. The conductive pressing piece is disposed outside the positive lead area or the negative lead area, the bolt enables the conductive pressing piece to be firmly pressed against and to be maintained in a close electrical contact with the positive lead area or the negative lead area, and the connecting portion is electrically connected to the positive lead terminal or the negative lead terminal of the case. By such arrangements, even if there is a dimension error in the core or the case, which can be overcome by the deformation of the conductive fixing assemblies, and thus the battery can be assembled successfully.

The secondary objective of the present invention is to provide an electrical connection structure for a core assembly of a secondary lithium battery, wherein the connecting ends of the conductive pressing pieces are directly pressed against and maintained in a close electrical contact with the respective layers of the positive lead area or the negative lead area, and the conductive pressing pieces are electrically connected to the positive or negative lead terminal. Since the structure of the present invention is very simple and the electrical connection is direct, which contributes to reduction of the resistance of the battery.

### BRIEF DESCRIPTION OF THE DRAWINGS

FIG. 1 is a cross sectional view of a conventional core structure for a secondary lithium battery disclosed in U.S. application Ser. No. 11/456119;

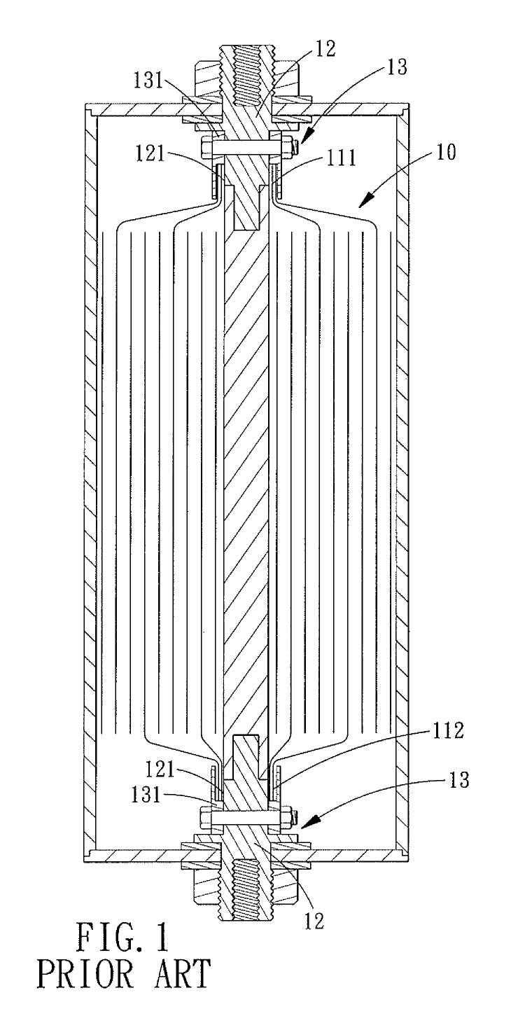

FIG. 2 is an exploded view of showing an electrical connection structure for a core assembly of a secondary lithium battery in accordance with the present invention;

FIG. 3 is an enlarged view of showing a part of the core structure for a secondary lithium battery in accordance with the present invention;

FIG. 4 is a cross sectional view in accordance with the present invention of showing that the electrical connection structure for a core assembly is disposed in a circular battery case;

FIG. 5 is a cross sectional view in accordance with the present invention of showing the interior of the battery case, wherein the core structure is additionally provided with conductive sleeve; and

FIG. 6 is a cross sectional view in accordance with the present invention of showing that the electrical connection structure for a core assembly is disposed in a square battery case.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

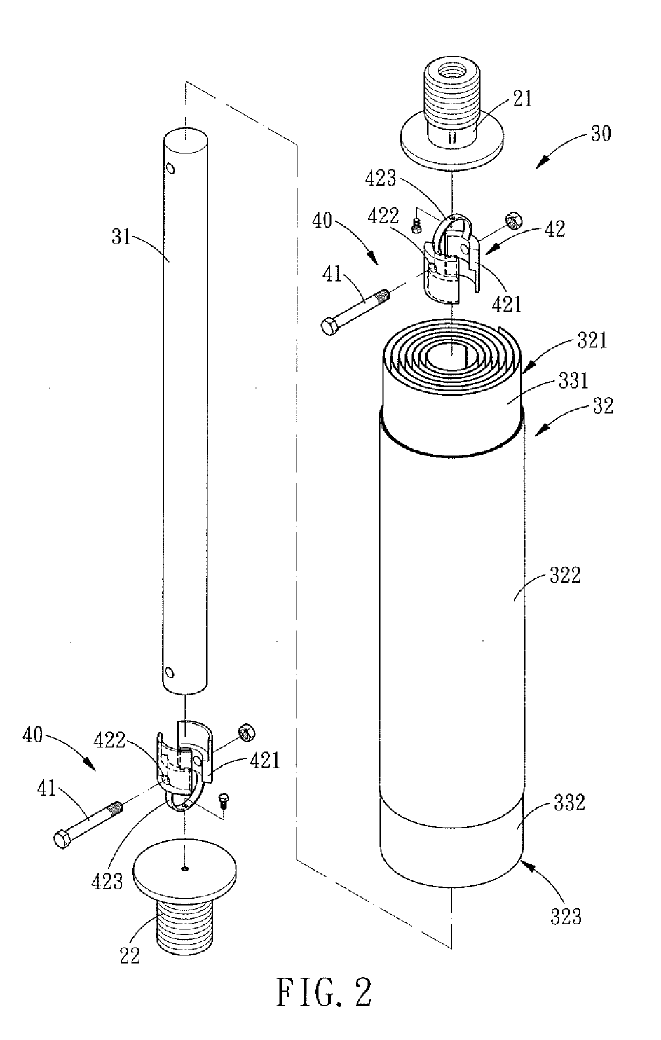

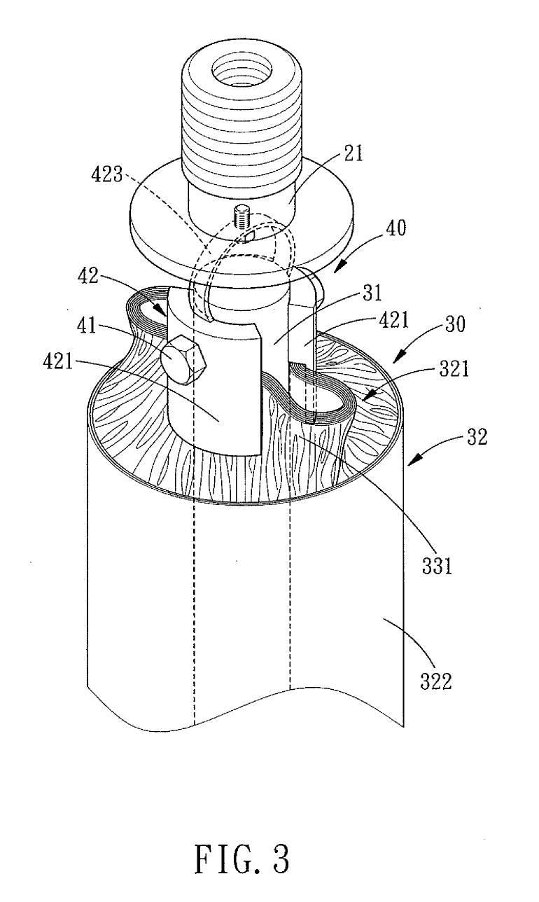

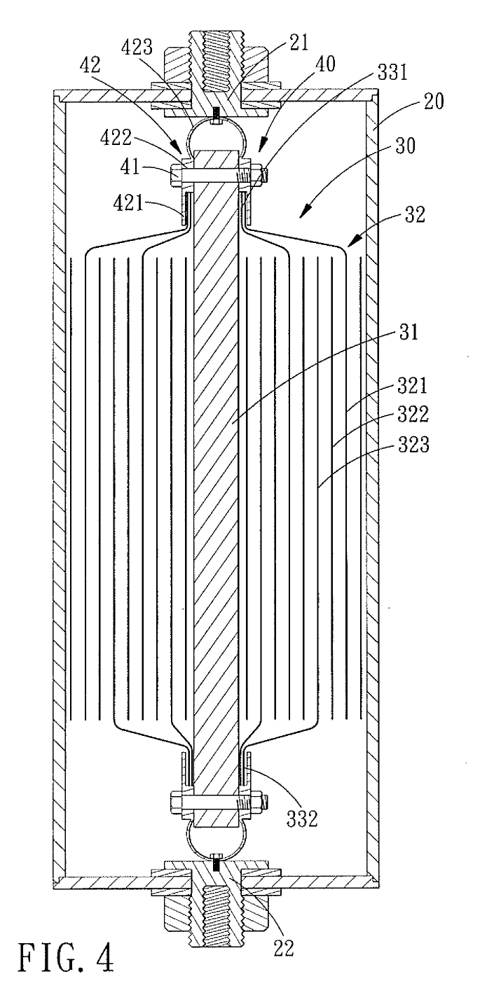

Referring to FIGS. 2-4, an electrical connection structure for a core assembly of a secondary lithium battery in accordance with the present invention is illustrated, wherein two conductive fixing assemblies 40 are arranged at both ends of the core assembly 30 and are electrically connected to the positive lead terminal 21 or the negative lead terminal 22 of the case 20 of the battery.

The core assembly 30 includes a core 31 and an electrode assembly 32. The electrode assembly 32 includes at least one positive layer 321, one separating layer 322 and one negative layer 323 that are superposed one another and then wind around the core 31. An uncoated area is formed at a side of the positive layer 321 for use as a positive lead area 331, and the negative layer 323 is formed at another side thereof opposite the positive layer 321 with an uncoated area for use as a negative lead area 332. The positive and negative lead areas 331, 332 protrude out of both sides of the core assembly 32.

Each of the conductive fixing assemblies 40 includes at least one bolt 41 and one conductive pressing piece 42. The conductive pressing piece 42 is a flexible and curved structure having two connecting ends 421 and a connecting portion 423 formed between the connecting ends 421. The conductive pressing piece 42 is disposed outside the positive lead area 331 or the negative lead area 332. The bolt 41 passes through the through hole 422 of the conductive pressing piece 42 and then is fixed on the core 31, so that the conductive pressing piece 42 is firmly pressed against and is maintained in a close electrical contact with the positive lead area 331 or the negative lead area 332, and the connecting portion 423 is electrically connected to the positive lead terminal 21 or the negative lead terminal 22 of the case 20.

The core structure and the arrangement relation of the components thereof are mentioned above. The present invention intends to further improve the design of the core structure and to use the conductive fixing assemblies as an electrical conductive connection for connecting the conductive pressing pieces to the positive lead terminal or the negative lead terminal, and the conductive fixing assemblies is a flexible structure. By such arrangements, even if there is a dimension error in the core or the case, which can be overcome by the deformation of the conductive fixing assemblies, and thus the battery can be assembled successfully.

Referring to FIGS. 2-4 again, the conductive fixing assemblies 40 serve as electrical conductive connection between the core 30 and the positive lead terminal 21 or the negative lead terminal 22. Since the conductive pressing piece 42 of the conductive fixing assemblies 40 is flexible, it can be deformed or lengthened to a certain extent. Therefore, even if there is a dimension error in the core or the case 20, which can be overcome by the deformation of the conductive fixing assemblies 40, and thus the core 30 and the case 20 can be assembled successfully.

It is to be noted that the connecting ends 421 of the conductive pressing pieces 42 are directly pressed against and are maintained in a close electrical contact with the respective layers of the positive lead area 331 or the negative lead area 332, and the conductive pressing pieces 42 are electrically connected to the positive lead terminal 21 and the negative lead terminal 22. Since the structure of the present invention is very simple and the electrical connection is direct, which contributes to the reduction of the resistance of the battery.

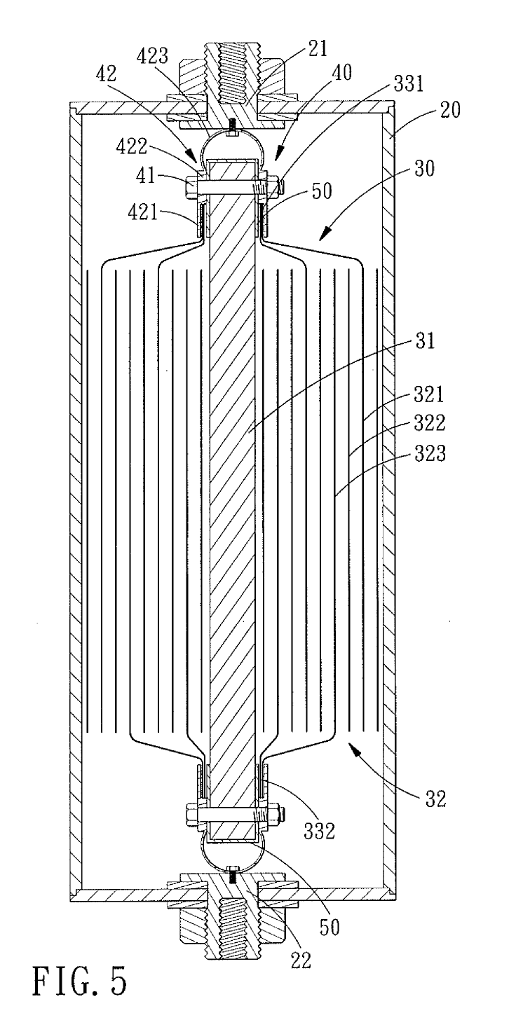

As shown in FIG. 5, either end of the core 31 can be covered with a conductive sleeve 50, when the conductive pressing pieces 42 are pressed against the positive and negative lead areas 331, 332, the conductive sleeve 50 can improve the electrical connection between the positive and negative lead areas 411, 431, thus increasing the current path in the charge and discharge process of the battery, and reducing the resistance of the battery.

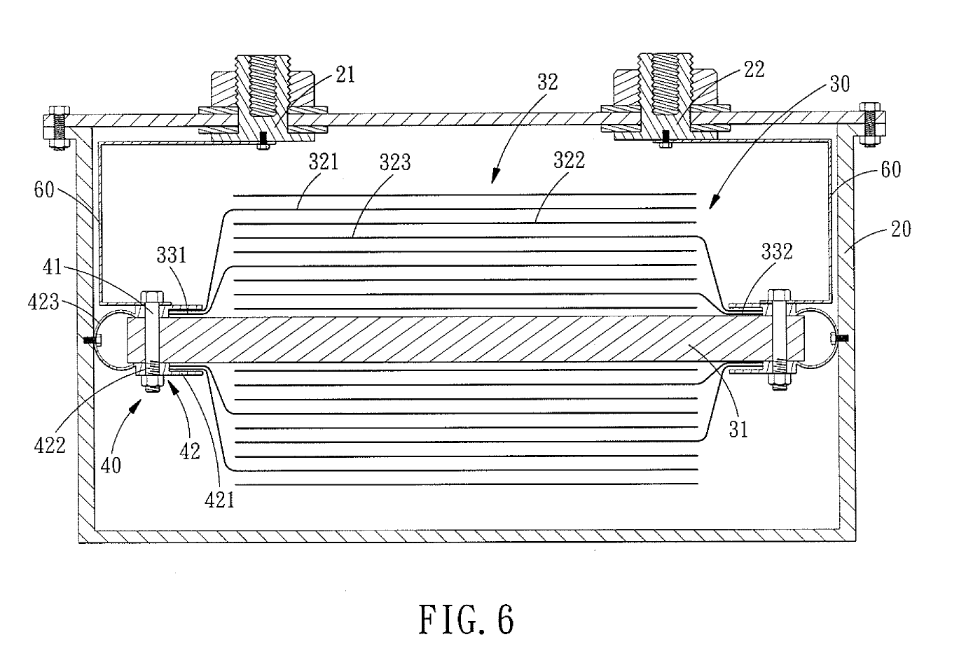

In addition to being applicable to a circular battery case, the design of the core structure of the present invention can also be used in a square battery case, as shown in FIG. 6. The core structure is additionally provided with two conductive members 60, one end of the conductive members 60 is connected to one of the conductive pressing pieces 42, and another end of conductive members 60 is connected to the positive lead terminal 21 or the negative lead terminal 22 of the case 20. This design meets the requirement that the positive lead terminal 21 and the negative lead terminal 22 of the square battery should be located at the same side.

While we have shown and described various embodiments in accordance with the present invention, it is clear to those skilled in the art that further embodiments may be made without departing from the scope of the present invention.

What is claimed is:

1. An electrical connection structure for a core assembly of a secondary lithium battery comprising: two conductive fixing assemblies arranged at both ends of a core assembly, the conductive fixing assemblies being electrically connected to a positive lead terminal or a negative lead terminal of a case of battery; wherein the core assembly includes a core and an electrode assembly, the electrode assembly includes at least one positive layer, one separating layer and one negative layer that are superposed one another and then wind around the core, an uncoated area is formed at a side of the positive layer for use as a positive lead area, and the negative layer is formed at another side thereof opposite the positive layer with an uncoated area for use as a negative lead area, the positive and negative lead areas protrude out of both sides of the core assembly;
each of the conductive fixing assemblies includes at least one bolt and one conductive pressing piece, the conductive pressing piece is a flexible and curved structure having two connecting ends and a connecting portion formed between the connecting ends, the conductive pressing piece is disposed outside the positive lead area or the negative lead area, the bolt passes through a through hole of the conductive pressing piece and then is fixed on the core, so that the conductive pressing piece is firmly pressed against and is maintained in a close electrical contact with the positive lead area or the negative lead area, and the connecting portion is electrically connected to the positive lead terminal or the negative lead terminal of the case.

2. The electrical connection structure for a core assembly of a secondary lithium battery as claimed in claim 1, wherein either end of the core is covered with a conductive sleeve.

3. The electrical connection structure for a core assembly of a secondary lithium battery as claimed in claim 1, wherein the case of the battery is circular.

4. The electrical connection structure for a core assembly of a secondary lithium battery as claimed in claim 1, wherein the case of the battery is square.

5. The electrical connection structure for a core assembly of a secondary lithium battery as claimed in claim 4, wherein the core assembly is additionally provided with two conductive members after being installed in a square case, one end of the respective conductive members is connected to the conductive pressing piece, and another end of the respective conductive members is connected to positive lead terminal or negative lead terminal of the battery.
